(19) United States
(12) Patent Application Publication
(10) Pub. No.: US 2010/0208089 A1
(43) Pub. Date: Aug. 19, 2010

(54) ANTI-SHAKE CAMERA

(75) Inventor: Jen-Tsorng CHANG, Tu-Cheng (TW)

Correspondence Address: PCE INDUSTRY, INC.;ATT. Steven Reiss, 288 SOUTH MAYO AVENUE, CITY OF INDUSTRY, CA, 91789, US

(73) Assignee: HON HAI PRECISION INDUSTRY CO., LTD., Tu-Cheng (TW)

(21) Appl. No.: 12/621,633

(22) Filed: Nov. 19, 2009

(30) Foreign Application Priority Data
Feb. 16, 2009 (CN) 200910300428.7

(51) Int. Cl. H04N 5/228

(52) U.S. Cl. 348/208.5; 348/E05.031

(57) ABSTRACT

An anti-shake camera includes a top plate having a through hole defined therein, a lens module, an auto-focus actuator fixedly mounted on the top plate, a bottom plate, an image sensor mounted on the bottom plate, a motion sensor disposed on the bottom plate, an elastic member connected between the top plate and the bottom plate, and a drive module. The motion sensor is configured for detecting a movement of the image sensor. The lens module is coupled to the auto-focus actuator in such a manner that an optical axis of the lens module aligns with the through hole of the top plate. The auto-focus actuator is for driving the lens module to achieve auto-focus. The drive module is for driving the lens module to move relative to the image sensor to compensate a movement of the image sensor based on a motion detection result of the motion sensor.

### BACKGROUND

1. Technical Field

The present disclosure relates to cameras, and particularly, to an anti-shake camera.

2. Description of Related Art

In normal use of a camera, light rays coming from an object transmit through the camera and fall on a particular region of the image sensor. The image sensor forms an image associated with the object at a first position.

However, while the image is captured, the camera may shake. As a result, either or both of the lens module and the image sensor may move slightly relative to the object. In such case, the light rays from the object may fall on a different region of the image sensor. That is, the image sensor may form an image associated with the object at a second position different from the previous first position thereof, resulting in a blurry image.

Therefore, a new anti-shake camera is desired to overcome the above-mentioned problems.

### BRIEF DESCRIPTION OF THE DRAWINGS

Many aspects of the present embodiments can be better understood with reference to the following drawings. The components in the drawings are not necessarily drawn to scale, the emphasis instead being placed upon clearly illustrating the principles of the present embodiments. Moreover, in the drawings, like reference numerals designate corresponding parts throughout the several views.

FIG. 1 is an exploded isometric view of an anti-shake camera according to a first embodiment.

FIG. 2 is an assembled view of the anti-shake camera of FIG. 1.

FIG. 3 is a block diagram showing a relationship between a motion sensor, a drive module, a first coil, and a second coil of the anti-shake camera of FIG. 1.

FIG. 4 is an exploded isometric view of an anti-shake camera according to a second embodiment.

FIG. 5 is an assembled view of the anti-shake camera of FIG. 4.

### DETAILED DESCRIPTION

Embodiments will now be described in detail below with reference to the drawings.

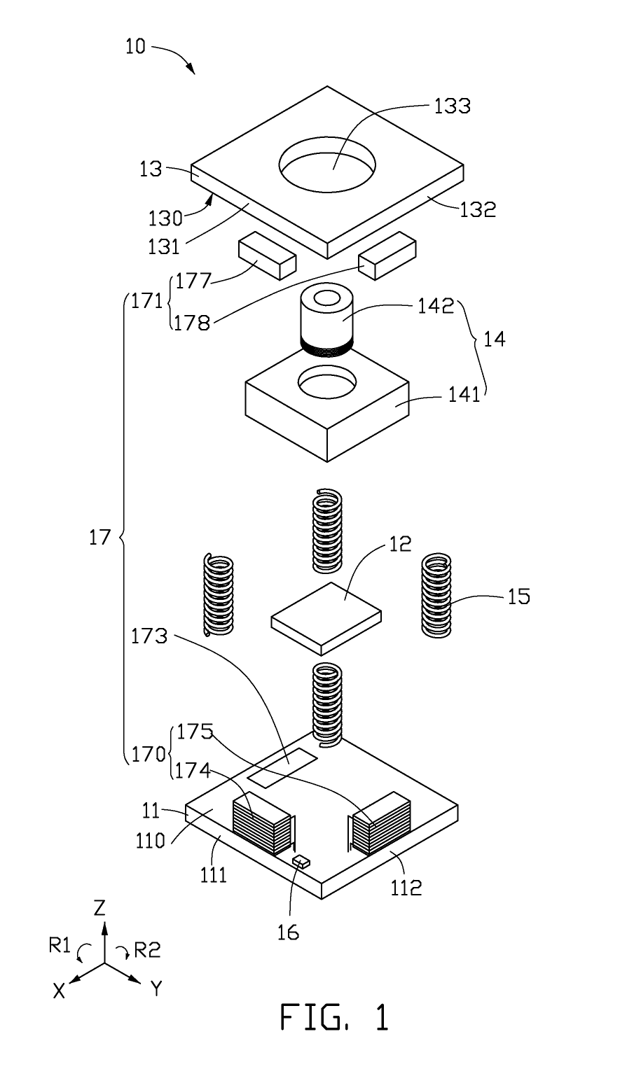

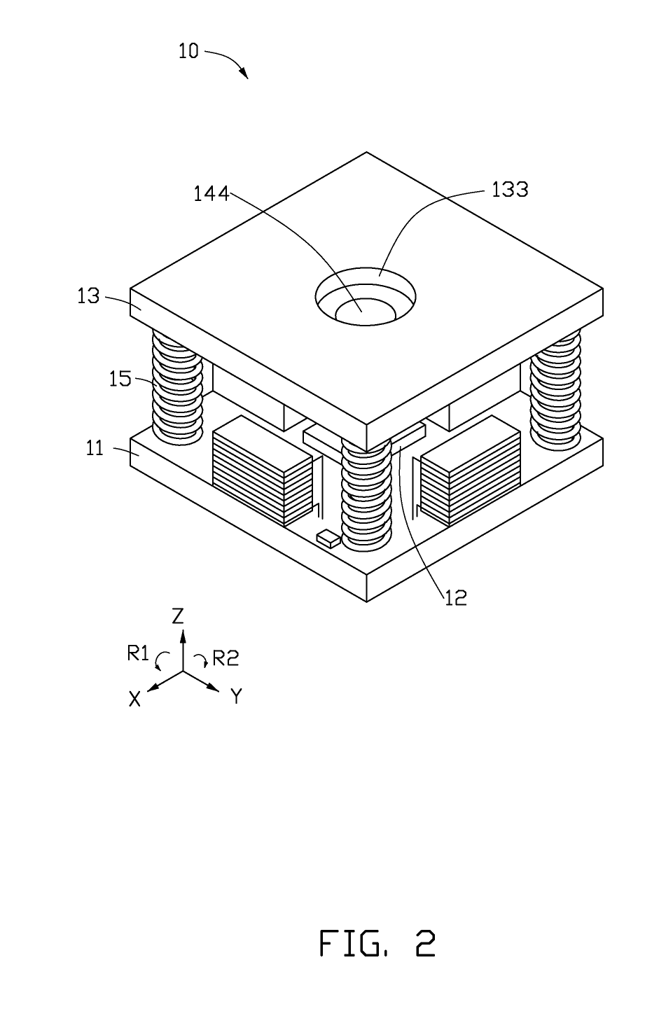

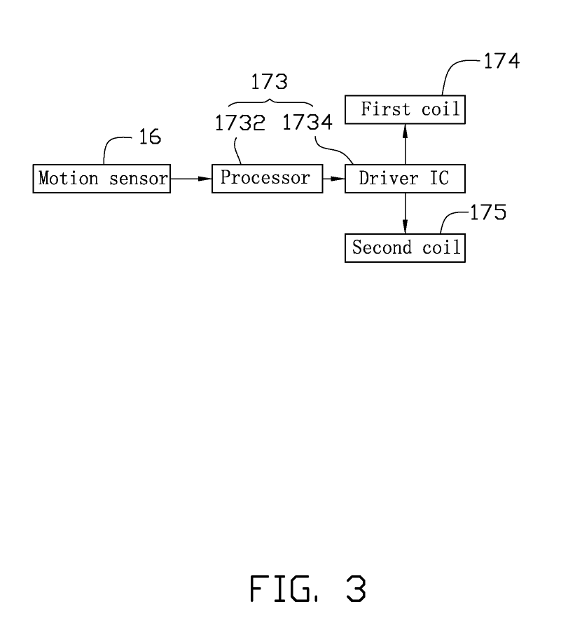

Referring to FIGS. 1-3, an anti-shake camera 10 according to a first embodiment of the present disclosure is shown. The anti-shake camera 10 includes a bottom plate 11, an image sensor 12, a top plate 13, an auto-focus (AF) module 14, a plurality of elastic members 15, a motion sensor 16, and a drive module 17.

The bottom plate 11 is substantially rectangular. The bottom plate 11 is securely mounted on a main body (not shown) of the anti-shake camera 10. The bottom plate 11 includes a top surface 110, a first sidewall 111 extending parallel to the Y axis, and a second sidewall 112 extending parallel the X axis. The top surface 110 is parallel with a plane defined on the X-Y axes. The Z axis is perpendicular to the top surface 110. The image sensor 12 is mounted on a surface of the bottom plate.

The top plate 13 defines a through hole 133 in a central portion. The through hole 133 allows light to pass through. The top plate 13 includes a bottom surface 130, a first sidewall 131 extending parallel the Y axis, and a second sidewall 132 extending parallel the X axis.

The AF module 14 includes a lens module 142 and an auto-focus actuator 141. The auto-focus actuator 141 is fixedly connected with the top plate 13. The AF actuator 141 has a through hole 144 defined therein. The lens module 142 is coupled in the through hole 144 of the AF actuator 14. The auto-focus actuator 141 is configured for driving the lens module 142 to move along an optical axis (not shown) of the lens module 142 for focusing.

In the present embodiment, the elastic members 15 are springs. Each elastic member 15 is connected between the bottom plate 11 and the top plate 13. Each elastic member 15 is aligned parallel the Z axis.

The motion sensor 16 is disposed on the bottom plate 11, and is configured for sensing a movement of the bottom plate 11 (i.e., a movement of the image sensor 12). The motion sensor 16 can be a gyro sensor.

The drive module 17 is configured for driving the AF module 14 to move relative to the image sensor 12 according to a motion detection result/signal of the motion sensor 16. The drive module 17 includes a first magnetic component 170, a second magnetic component 171 and a control circuit 173. At least one of the first and the second magnetic components 170, 171 is electromagnetic so that a magnetic force between the first and the second magnetic components 170, 171 is controllable by the control circuit 173.

In the present embodiment, the first magnetic component 170 is an electromagnet, and is electrically connected with the control circuit 173. The first magnetic component 170 includes a first coil 174 and a second coil 175. The first coil 174 is arranged on the top surface 110 of the bottom plate 11, and is oriented along the first sidewall 174. The second coil 175 is disposed on the top surface 110 of the bottom plate 11, and is oriented along the second sidewall 112.

In the present embodiment, the second magnetic component 171 includes a first magnet 177 and a second magnet 178, both of which are permanent magnets. The first magnet 177 is arranged along the first sidewall 131, and the second magnet 178 is aligned along the second sidewall 132. The first magnet 177 is spatially corresponding to the first coil 174, and the second magnet 178 is spatially corresponding to the second coil 175.

The control circuit 173 includes a processor 1732 and a driver integrated circuit (IC) 1734 electrically connected with the processor 1732. The processor 1732 is electrically connected with the motion sensor 16. The driver IC 1734 is electrically connected with the first coil 174 and the second coil 175. The processor 1732 can be, for example, a digital signal processor (DSP) position controller.

In operation, at the beginning of capturing an image with the anti-shake camera 10, the four elastic members 15 are in normal state, and the top plate 13 is parallel to the bottom plate 11. At this moment, the anti-shake camera 10 forms an image associated with an object (not shown) on a first position of the image sensor 12.

While the image is captured, the anti-shake camera 10 may be shaken. The shake may cause the bottom plate 11 to rotate around the Y axis in a first direction R1 relative to the object, for example. Accordingly, the image sensor 12 and the AF module 14 are rotated with the bottom plate 11. The motion sensor 16 detects a movement of the bottom plate 11 and sends a motion detection result to the processor 1732. Based on the motion detection result, the processor 1732 computes a compensating adjustment for the AF module 14 in order to reposition the image on the first position of the image sensor 12. For an example, the AF module 14 may need to rotate a computed compensating angle around the Y axis in a second direction R2. Then the processor 1732 sends a signal to the driver IC 1734, and the driver IC 1734 apply a voltage to the first coil 174 in response to the signal such that the first coil 174 repels the first magnet 177.

Hence, the top plate 14 together with the AF module 14 are rotated the predetermined angle around the Y axis in the second direction R2, two elastic members 15 adjacent to the first sidewall 111 become stretched, while the other two elastic members 15 away from the first sidewall 111 become compressed. As a result, the anti-shake camera 10 forms an image associated with the object (not shown) on the first position of the image sensor 12. That is, the image associated with the object is formed on the same position of the image sensor before and while the anti-shake camera 10 is shaken. In this way, the anti-shake camera 10, after a shake of the anti-shake camera 10, captures a stabilized image of the object, which is substantially identical with an image captured without the shake of the anti-shake camera 10. Accordingly, a blurred image is eliminated.

It is to be understood that when the anti-shake camera 10 shakes, the bottom plate 11 may be only rotated around the X axis, or be rotated around both the X axis and the Y axis. In these circumstances, the second coil 175 should be activated to adjust a position of the top plate 13.

In another embodiment, the first magnet 177 and the second magnet 178 can be replaced by two coils correspondingly, while keeping the first coil 174 and the second coil 175.

In a further embodiment, the first coil 174 and the second coil 175 can be replaced by two permanent magnets correspondingly, while the first magnet 177 and the second magnet 178 can be replaced by two coils respectively.

In a still further embodiment, the first coil 174 can be replaced by a permanent magnet while the second coil 175 still exists, and the first magnet 177 can be substituted a coil while the second magnet 178 still exists.

In a yet still further embodiment, the four elastic members 15 can be a light permeable elastic cushion sandwiched between the AF module 14 and the bottom plate 11.

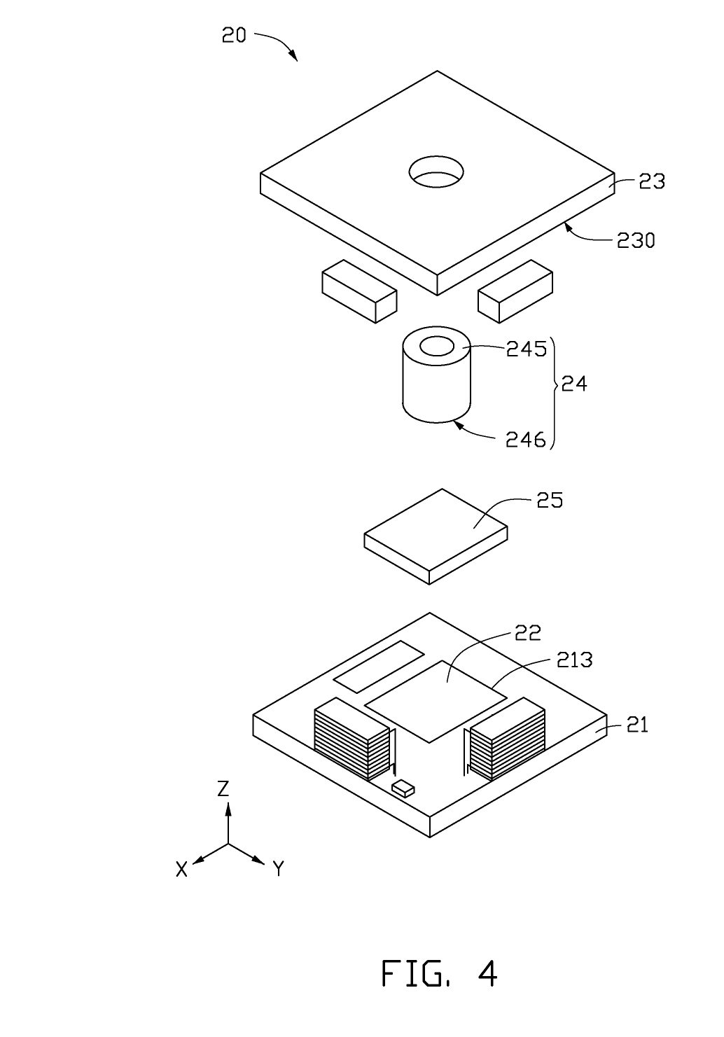

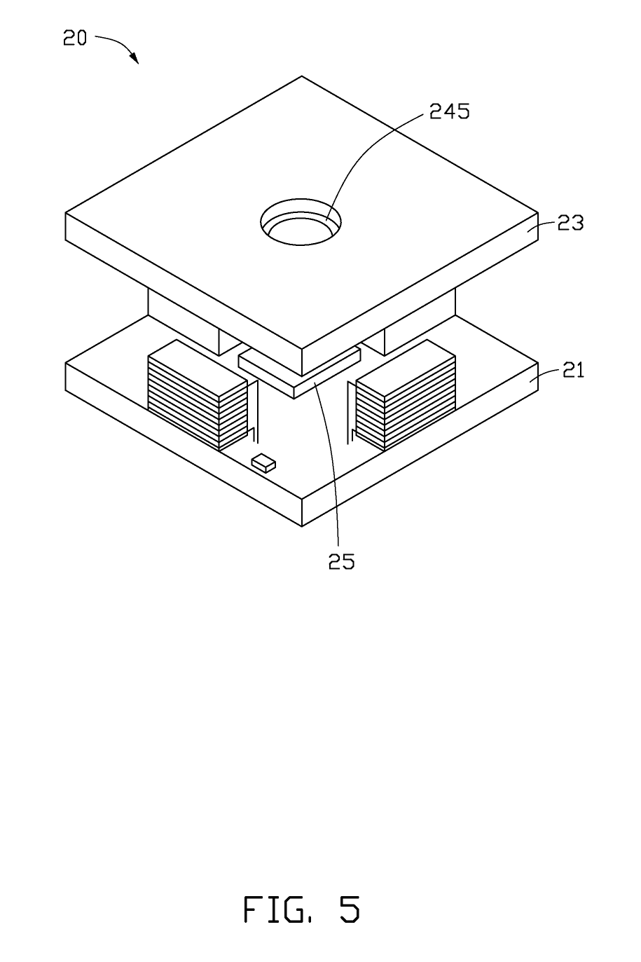

Referring to FIGS. 4-5, an anti-shake camera 20 according to a second embodiment is shown. The anti-shake camera 20 includes a bottom plate 21, a top plate 23, a lens module 24, an elastic member 25, and an image sensor 22. The anti-shake camera 20 is similar to the anti-shake camera 10 of FIGS. 1-3, except that no auto-focus actuator is employed, the elastic member 25 is a light permeable elastic cushion, the bottom plate 21 defines an accommodating space 213 therein, and the image sensor 22 is received in the accommodating space 213.

The top plate 23 includes a bottom surface 230. The lens module 24 includes a top surface 245 and a bottom surface 246. The top surface 245 of the lens module 24 is adhered to the bottom surface 230 of the top plate 23. The elastic member 25 is sandwiched between the bottom surface 246 of the lens module 24 and the bottom plate 21, and is fixedly mounted on the bottom plate 21.

While certain embodiments have been described and exemplified above, various other embodiments from the foregoing disclosure will be apparent to those skilled in the art. The present invention is not limited to the particular embodiments described and exemplified but is capable of considerable variation and modification without departure from the scope and spirit of the appended claims.

What is claimed is:

1. An anti-shake camera comprising:
a top plate having a through hole defined therein;
a lens module;
an auto-focus actuator fixedly mounted on the top plate, the lens module being coupled to the auto-focus actuator in such a manner that an optical axis of the lens module aligns with the through hole of the top plate, the auto-focus actuator being configured for driving the lens module to achieve auto-focus;
a bottom plate;
an image sensor mounted on the bottom plate;
a motion sensor disposed on the bottom plate and configured for detecting a movement of the image sensor;
an elastic member connected between the top plate and the bottom plate; and
a drive module configured for driving the lens module to move relative to the image sensor to compensate a movement of the image sensor based on a motion detection result of the motion sensor.

2. The anti-shake camera of claim 1, wherein the elastic member comprises a plurality of springs, and each spring is connected between the top plate and the bottom plate.

3. The anti-shake camera of claim 1, wherein the drive module comprises a first magnetic component formed on the top plate, a second magnetic component formed on the bottom plate, and a control circuit, at least one of the first and the second magnetic components is an electromagnet, and the control circuit is configured for controlling a magnetic force between the first and the second magnetic components, thereby driving the lens module to move.

4. The anti-shake camera of claim 3, wherein the first magnetic component comprises a first permanent magnet and a second permanent magnet arranged along two adjacent sides of the top plate, the second magnetic component comprises a first coil and a second coil arranged along two adjacent sides of the bottom plate, and the first and the second permanent magnets are spatially corresponding to the first and the second coils respectively.

5. The anti-shake camera of claim 3, wherein the first magnetic component comprises a first permanent magnet and a first coil arranged along two adjacent sides of the top plate, the second magnetic component comprises a second permanent magnet and a second coil arranged along two adjacent sides of the bottom plate, and the first permanent magnet and the first coil are spatially corresponding to the second coil and the second permanent magnet respectively.

6. The anti-shake camera of claim 3, wherein the first magnetic component comprises a first coil and a second coil arranged along two adjacent sides of the top plate, the second magnetic component comprises a third coil and a fourth coil arranged along two adjacent sides of the bottom plate, and the first and the second coils are spatially corresponding to the third and the fourth coils respectively.

7. The anti-shake camera of claim 3, wherein the first magnetic component comprises a first coil and a second coil arranged along two adjacent sides of the top plate, the second magnetic component comprises a first permanent magnet and a second permanent magnet arranged along two adjacent sides of the bottom plate, and the first and the second permanent magnets are spatially corresponding to the first and the second coils respectively.

8. The anti-shake camera of claim 3, wherein the control circuit comprises a processor and a driver IC electrically connected with the processor, the processor is electrically connected with the motion sensor, and the driver IC is electrically connected with the electromagnet.

9. The anti-shake camera of claim 1, wherein the motion sensor comprises a gyro sensor.

10. The anti-shake camera of claim 1, wherein the elastic member comprises a light permeable elastic cushion sandwiched between the auto-focus actuator and the image sensor.

11. An anti-shake camera for capturing an image of an object, the anti-shake camera comprising:
a top plate having a through hole defined therein;
a lens module;
an auto-focus actuator fixedly mounted on the top plate, the lens module being coupled to the auto-focus actuator in such a manner that an optical axis of the lens module aligns with the through hole of the top plate, the auto-focus actuator being configured for driving the lens module to achieve auto-focus;
a bottom plate;
an image sensor mounted on the bottom plate;
a motion sensor disposed on the bottom plate and configured for detecting a movement of the image sensor;
an elastic member connected between the top plate and the bottom plate; and
a drive module configured for driving the lens module to move relative to the image sensor such that the anti-shake camera forms an image associated with the object on an identical position of the image sensor before and after a shake of the anti-shake camera.

12. The anti-shake camera of claim 11, wherein the elastic member comprises a plurality of springs, and each spring is connected between the top plate and the bottom plate.

13. The anti-shake camera of claim 11, wherein the drive module comprises a first magnetic component formed on the top plate, a second magnetic component formed on the bottom plate, and a control circuit, at least one of the first and the second magnetic components is an electromagnet, and the control circuit is configured for controlling a magnetic force between the first and the second magnetic components, thereby driving the lens module to move.

14. The anti-shake camera of claim 13, wherein the first magnetic component comprises a first permanent magnet and a second permanent magnet arranged along two adjacent sides of the top plate, the second magnetic component comprises a first coil and a second coil arranged along two adjacent sides of the bottom plate, and the first and the second permanent magnets are spatially corresponding to the first and the second coils respectively.

15. The anti-shake camera of claim 13, wherein the first magnetic component comprises a first permanent magnet and a first coil arranged along two adjacent sides of the top plate, the second magnetic component comprises a second permanent magnet and a second coil arranged along two adjacent sides of the bottom plate, and the first permanent magnet and the first coil are spatially corresponding to the second coil and the second permanent magnet respectively.

16. The anti-shake camera of claim 13, wherein the first magnetic component comprises a first coil and a second coil arranged along two adjacent sides of the top plate, the second magnetic component comprises a third coil and a fourth coil arranged along two adjacent sides of the bottom plate, and the first and the second coils are spatially corresponding to the third and the fourth coils respectively.

17. The anti-shake camera of claim 13, wherein the first magnetic component comprises a first coil and a second coil arranged along two adjacent sides of the top plate, the second magnetic component comprises a first permanent magnet and a second permanent magnet arranged along two adjacent sides of the bottom plate, and the first and the second permanent magnets are spatially corresponding to the first and the second coils respectively.

18. The anti-shake camera of claim 13, wherein the control circuit comprises a processor and a driver IC electrically connected with the processor, the processor is electrically connected with the motion sensor, and the driver IC is electrically connected with the electromagnet.

19. The anti-shake camera of claim 11, wherein the motion sensor comprises a gyro sensor.

20. An anti-shake camera for capturing an image of an object, the anti-shake camera comprising:
a top plate having a through hole defined therein;
a lens module;
an auto-focus actuator fixedly mounted on the top plate, the lens module being coupled to the auto-focus actuator in such a manner that an optical axis of the lens module aligns with the through hole of the top plate, the auto-focus actuator being configured for driving the lens module to achieve auto-focus;
a bottom plate;
an image sensor mounted on the bottom plate;
a motion sensor disposed on the bottom plate and configured for detecting a movement of the image sensor;
an elastic member connected between the top plate and the bottom plate; and
a drive module configured for driving the lens module to move relative to the image sensor so as to counteract movement of the object relative to the lens module such that the anti-shake camera can, after a shake of the anti-shake camera, capture a stabilized image of the object which is substantially identical with an image thereof captured without the shake of the anti-shake camera.
